(19) United States
(12) Patent Application Publication
(10) Pub. No.: US 2026/0050601 A1
(43) Pub. Date: Feb. 19, 2026

(54) LEARNING MULTI-TASK AS A SEQUENCE WITH MULTI-DISTRIBUTION DATA

(71) Applicant: Etsy, Inc., Brooklyn, NY (US)

(72) Inventors: Audrey Chen, Brooklyn, NY (US); Austin Clapp, Brooklyn, NY (US); Sheng-Min Shih, Brooklyn, NY (US); Xiaoting Zhao, Queens, NY (US); Mahir Yavuz, Brooklyn, NY (US); Siqi Wang, Brooklyn, NY (US)

(21) Appl. No.: 19/298,911

(22) Filed: Aug. 13, 2025

Related U.S. Application Data
(60) Provisional application No. 63/683,632, filed on Aug. 15, 2024.

(51) Int. Cl. G06F 16/2457

(52) U.S. Cl. CPC G06F 16/24578

(57) ABSTRACT

Methods, system, and apparatus for providing receiving, from a user device, at a computing server, and during a web session on an exchange platform, a set of data including data related to a user-submitted query and interaction data. Using the set of data, a first set of listings is identified that are responsive to the user-submitted query and that correspond listings of a digital component on the platform. The server inputs to a neural network (NN) a set of sequential input features, where the neural network is trained to perform k tasks based on a common set of input data, wherein the k tasks include (1) predicting interaction activity for a candidate listing and (2) predicting affirmative action activity for the candidate listing. The NN generates a set of sequential output scores, which can be used to generate a ranked set of listings.

### CROSS-REFERENCE TO RELATED APPLICATIONS

This application claims the benefit under 35 U.S.C. § 119(c) of U.S. Patent Application No. 63/683,632, entitled “LEARNING MULTI-TASK AS A SEQUENCE WITH MULTI-DISTRIBUTION DATA,” filed Aug. 15, 2024. The disclosure of the foregoing application is incorporated herein by reference in its entirety for all purposes.

### TECHNICAL FIELD

This specification relates to ranking techniques and more particularly to ranking listings of digital components provided on an exchange platform.

### BACKGROUND

An exchange platform enables exchange of goods, content, and services between end users and providers. Providers can list or provide their goods, contents, and services on the exchange platform, and end users obtain the goods, content, and services from the providers via the exchange platform. The exchange platform can include front-end systems that interface with users and providers and can include back-end systems that perform processing and compute operations based on user and provider inputs and generate exchange outcomes.

A user device, or an application running on the user device, can communicate with the exchange platform, which can provide a user interface for display on the user device, via which the user can search for item listings. For example, the user interface can include a search field that accepts text from the user. The user interface can communicate the search text to the exchange platform, which can utilize a search engine to identify item listings responsive to the search text. The exchange platform can then provide the item listings to the user interface on the user device to display the item listings. Typically, the item listings are displayed as a list to the user and the user scrolls the list to identify the desired item. Upon selecting the desired item, the user interface can allow the user to acquire the item.

The search engine can utilize search algorithms to search a listings database to identify a set of relevant listings and a ranking algorithm to rank the listings, such that the higher ranked results are provided higher on the results provided to the user. In some instances, machine learning algorithms can be utilized for ranking the listings. However, these machine learning algorithms can suffer from inaccuracies in cases where ranking based on multiple tasks is involved and where training data includes category-based variations. Multiple tasks can include various actions carried out by a user when purchasing an item. For example, the multiple tasks can include actions such as clicking on a listing, placing an item on the listing in the shopping cart, purchasing the item in the shopping cart, etc. Training data can include category-based variations such as region-based variations. For example, features such as number of views for each listing per query may vary by region. Some features might be uniformly distributed in certain region and non-uniform in other regions. Traditional machine learning approaches fail to effectively take into consideration both multiple tasks and category-based variations simultaneously. In particular, traditional approaches do not take into consideration the sequential nature of the multiple tasks and do not train the machine learning models based on category-based distribution variations.

### SUMMARY

In one aspect, this application discusses techniques for ranking listings of digital components provided on an exchange platform. The techniques can simultaneously take into consideration sequential nature of various tasks as well as features with category-based distribution variations. The techniques provide machine learning models that can treat the tasks as sequential tasks. For example, the machine learning models can be trained to predict probabilities of a “click” task followed by an “acquire” task. In addition, the input features can be separated into category-invariant and category-variant features. The category-variant features can be processed with category embeddings such that the category-variant features are transformed according to their respective category. The transformed category-variant features are combined with the category-invariant features and provided to a trained sequential neural network model that provides a score for each task. The listings can be ranked by combining the scores for all the tasks.

Particular examples of the subject matter described in this specification can be implemented so as to realize one or more of the following advantages. By treating the tasks as a sequence, the techniques not only extract and utilizes sequential relationships between the tasks, but also reduces redundant computations among related tasks. As a result, the accuracy of the scores generated by the neural network for each task can be improved. Further, by reducing the redundant computations, speed of computation can be increased, and the computation power can be reduced. By capturing category-based features, the machine learning models can be trained to provide more accurate scores for a more extensive and diverse dataset.

In some aspects, the techniques discussed herein are related to a computer-implemented method, including receiving, from a user device, at a computing server, and during a web session on an exchange platform, a set of data including data related to a user-submitted query and interaction data; identifying, using the set of data, a first set of listings that are responsive to the user-submitted query, wherein each listing in the first set of listings corresponds to a listing of a digital component provided on the exchange platform; inputting, by the computing server to a neural network that is trained using sequential learning, a set of sequential input features, wherein the neural network is trained to perform k tasks based on a common set of input data, wherein the k tasks include at least (1) predicting interaction activity for a candidate listing and (2) predicting affirmative action activity for the candidate listing; obtaining, from the neural network and for the set of input features, a set of sequential output scores, wherein each score in the set of sequential output scores corresponds to a task in the k tasks; generating, based on the set of sequential output scores and the first set of listings, a ranked set of listings; and providing, by the computing server and to an application executing on the user device, the ranked set of listings.

In some examples, the method can include generating a raw set of input features using the received set of data; identifying, from among the raw set of input features, a set of region-variant features and a set of region-invariant features; generating, for a particular region, a set of region-variant mask weights; combining the set of region-variant mask weights with the set of region-variant features to obtain a combined set of region-variant features; processing, using an initial layer of the neural network, the set of region-invariant features to obtain a transformed set of region-invariant features; and combining the transformed set of region-invariant features with the combined set of region-variant features to obtain the set of sequential input features. In some examples, combining the set of region-variant mask weights with the set of region-variant features to obtain the combined set of region-variant features includes multiplying the set of region-variant mask weights with the set of region-variant features to obtain the combined set of region-variant features. In some examples, the number of region-variant mask weights in the set of region-variant mask weights is equal to a number k of tasks. In some examples, the region-invariant features are transformed into a sequence in the transformed set of region-invariant features and the region-variant features are transformed into a sequence in the combined set of region-variant features. In some examples, the neural network is trained on sequential data capturing a user interaction with a listing, the user interaction including at least one of a click task, an add to cart task, and an acquisition task. In some examples, the method includes generating the ranked set of listings from the first set of listings based on a single score resulting from a weighted sum of the set of sequential output scores.

In some aspects, the techniques discussed herein are related to one or more non-transitory computer-readable storage media storing instructions that when executed by one or more processors cause the one or more processors to perform operations for providing a ranked set of listings, the operations including receiving, from a user device, at a computing server, and during a web session on an exchange platform, a set of data including data related to a user-submitted query and interaction data; identifying, using the set of data, a first set of listings that are responsive to the user-submitted query, wherein each listing in the first set of listings corresponds to a listing of a digital component provided on the exchange platform; inputting, by the computing server to a neural network that is trained using sequential learning, a set of sequential input features, wherein the neural network is trained to perform k tasks based on a common set of input data, wherein the k tasks include at least (1) predicting interaction activity for a candidate listing and (2) predicting affirmative action activity for the candidate listing; obtaining, from the neural network and for the set of input features, a set of sequential output scores, wherein each score in the set of sequential output scores corresponds to a task in the k tasks; generating, based on the set of sequential output scores and the first set of listings, a ranked set of listings; and providing, by the computing server and to an application executing on the user device, the ranked set of listings.

In some examples, the operations can include generating a raw set of input features using the received set of data; identifying, from among the raw set of input features, a set of region-variant features and a set of region-invariant features; generating, for a particular region, a set of region-variant mask weights; combining the set of region-variant mask weights with the set of region-variant features to obtain a combined set of region-variant features; processing, using an initial layer of the neural network, the set of region-invariant features to obtain a transformed set of region-invariant features; and combining the transformed set of region-invariant features with the combined set of region-variant features to obtain the set of sequential input features. In some examples, the operations include comparing region-based distributions of the raw set of input features; identifying those raw set of features that have region-based distributions that different over a threshold value as the region-variant features and the remainder of the raw set of features as region-invariant features. In some examples, combining the set of region-variant mask weights with the set of region-variant features to obtain the combined set of region-variant features includes multiplying the set of region-variant mask weights with the set of region-variant features to obtain the combined set of region-variant features. In some examples, the number of region-variant mask weights in the set of region-variant mask weights is equal to a number k of tasks. In some examples, the region-invariant features are transformed into a sequence in the transformed set of region-invariant features and the region-variant features are transformed into a sequence in the combined set of region-variant features. In some examples, the neural network is trained on sequential data capturing a user interaction with a listing, the user interaction including at least one of a click task, an add to cart task, and an acquisition task. In some examples, the operations include generating the ranked set of listings from the first set of listings based on a single score resulting from a weighted sum of the set of sequential output scores.

In some aspects, the techniques discussed herein are related to a system including one or more processors; and one or more storage devices storing instructions that when executed by the one or more processors to perform operations for providing a ranked set of listings, the operations including: receiving, from a user device, at a computing server, and during a web session on an exchange platform, a set of data including data related to a user-submitted query and interaction data; identifying, using the set of data, a first set of listings that are responsive to the user-submitted query, wherein each listing in the first set of listings corresponds to a listing of a digital component provided on the exchange platform; inputting, by the computing server to a neural network that is trained using sequential learning, a set of sequential input features, wherein the neural network is trained to perform k tasks based on a common set of input data, wherein the k tasks include at least (1) predicting interaction activity for a candidate listing and (2) predicting affirmative action activity for the candidate listing; obtaining, from the neural network and for the set of input features, a set of sequential output scores, wherein each score in the set of sequential output scores corresponds to a task in the k tasks; generating, based on the set of sequential output scores and the first set of listings, a ranked set of listings; and providing, by the computing server and to an application executing on the user device, the ranked set of listings.

In some examples, the operations can include generating a raw set of input features using the received set of data; identifying, from among the raw set of input features, a set of region- variant features and a set of region-invariant features; generating, for a particular region, a set of region-variant mask weights; combining the set of region-variant mask weights with the set of region-variant features to obtain a combined set of region-variant features; processing, using an initial layer of the neural network, the set of region-invariant features to obtain a transformed set of region-invariant features; and combining the transformed set of region-invariant features with the combined set of region-variant features to obtain the set of sequential input features. In some examples, the operations include comparing region-based distributions of the raw set of input features; identifying those raw set of features that have region-based distributions that different over a threshold value as the region-variant features and the remainder of the raw set of features as region-invariant features. In some examples, combining the set of region-variant mask weights with the set of region-variant features to obtain the combined set of region-variant features includes multiplying the set of region-variant mask weights with the set of region-variant features to obtain the combined set of region-variant features. In some examples, the number of region-variant mask weights in the set of region-variant mask weights is equal to a number k of tasks. In some examples, the region-invariant features are transformed into a sequence in the transformed set of region-invariant features and the region-variant features are transformed into a sequence in the combined set of region-variant features. In some examples, the neural network is trained on sequential data capturing a user interaction with a listing, the user interaction including at least one of a click task, an add to cart task, and an acquisition task. In some examples, the operations include generating the ranked set of listings from the first set of listings based on a single score resulting from a weighted sum of the set of sequential output scores.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which an exchange platform facilitates an exchange of goods, services, or content between providers and users.

FIG. 2 shows a block diagram of a portion of the exchange platform discussed in relation to FIG. 1.

FIG. 3 shows a block diagram with additional details of the ranking engine and the neural network discussed herein in relation to FIGS. 1 and 2.

FIG. 4 shows example region-based distributions of features.

FIG. 5 shows a flow diagram of an example process for ranking listings.

Like reference numbers and designations in the various drawings indicate like elements.

### DETAILED DESCRIPTION

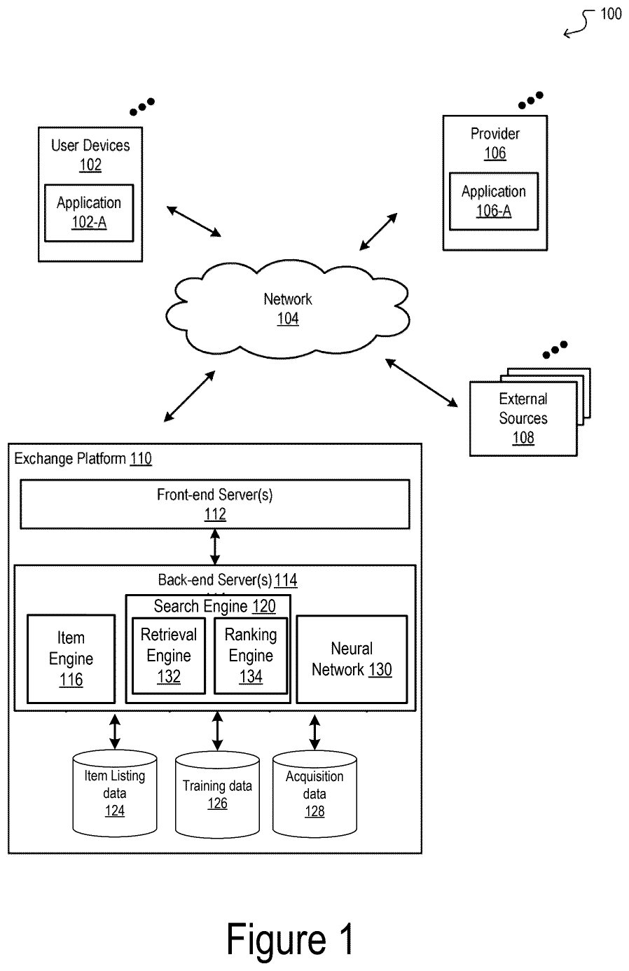

FIG. 1 is a block diagram of an example environment 100 in which an exchange platform facilitates an exchange of goods, services, or content between providers and users. The example environment 100 includes a network 104, such as a local area network (LAN), a wide area network (WAN), the Internet, or a combination thereof. The network 104 connects one or more user devices 102, one or more provider devices 106, an exchange platform 110, and one or more external sources 108.

User device 102 and provider device 106 are electronic devices that are capable of requesting and receiving content and resources over the network 104. Examples of such devices include personal computers, mobile communication devices, digital assistant devices, and other devices that can send and receive data over the network 104.

The exchange platform 110 is a computing platform that can be operated and maintained by an exchange service provider. The exchange platform 110 enables providers to list their items on the exchange platform 110 and enables users to obtain the item listed on the exchange platform 110. As depicted in the block diagram of FIG. 1, the exchange platform 110 is depicted as a single block with various sub-blocks. However, while the exchange platform 110 could be a single device or single set of devices, this specification contemplates that the exchange platform 110 could also be a group of devices, or even multiple different systems that communicate with each other to enable the exchange of goods, services, and/or content on the platform. Exchange platform 110 could also be a provider of items or may be an entity different from the provider, as shown in FIG. 1.

A provider uses an application 106-A executing on a provider device 106 to communicate with the exchange platform 110 to, for example, create or manage listings of items of provider on the exchange platform 110 and/or perform other appropriate tasks related to the exchange platform 110 (e.g., transfer an amount to the provider based on items obtained by users). The application 106-A can transmit data to, and receive data from, the exchange platform 110 over the network 104. The application 106-A can be implemented as a native application developed for a particular platform or a particular device, web browser that provides a web interface, or another appropriate type of application. The application 106-A can present and detect user interactions (e.g., user's touch, mouse clicks, etc.) with various interfaces that enable, for example, the provider to create and manage listings of the provider's items on the exchange platform 110.

Users of a user device 102 can use an application 102-A to communicate with the exchange platform 110 to, for example, view listings of items, search for items, obtain items, and/or perform other appropriate tasks related to the exchange platform 110. In some examples, listings of items can include data that is associated with items or services that are for sale on the exchange platform 110. For example, the data can include images, text, multimedia, etc. associated with an item or service that is listed for sale. In some examples, listings of items are not limited to data associated with items or services provided for sale on the exchange platform 110 and can refer to data associated with other digital components that may be provided on the exchange platform 110 or other electronic platforms. Digital components can refer to a discrete unit of digital content or digital information (e.g., a video clip, an audio clip, a multimedia clip, an image, text, or another unit of content). A digital component can electronically be stored in a physical memory device as a single file or in a collection of files, and digital components can take the form of video files, audio files, multimedia files, image files or text files. The techniques discussed herein can be applied to listings of items as well of listings of digital components provided on the exchange platform 110 or other platforms. The listings of digital components can be stored and processed in a manner similar to the listings of items discussed herein.

The application 102-A can transmit data to, and receive data from, the exchange platform 110 over the network 104. The application 102-A can be implemented as a native application developed for a particular platform or a particular device, web browser that provides a web interface, or another appropriate type of application. The application 102-A can present and detect user interactions (e.g., user's touch, mouse clicks, etc.) with various interfaces that enable, for example, the user to view listings of items, search for items, obtain items, and/or perform other appropriate tasks related to the exchange platform 110.

The exchange platform 110 includes one or more front-end servers 112 and one or more back-end servers 114. The front-end servers 112 can transmit data to, and receive data from, user devices 102 and provider devices 106, over the network 104. For example, the front-end servers 112 can provide to, applications 102-A and 106-A executing on user devices 102 and provider devices 106, respectively, interfaces and/or data for presentation with the interfaces. The front-end servers 112 can also receive data specifying user interactions with the interfaces provided by the front-end servers 112 to user devices 102 and provider devices 106. The front-end servers 112 can update the interfaces, provide new interfaces, and/or update the data presented by the interfaces presented in applications 102-A and 106-A, respectively, based on user/provider interactions with user devices 102 and provider devices 106.

The front-end servers 112 can also communicate with the back-end servers 114. For example, the front-end servers 112 can identify data to be processed by the back-end servers 114, e.g., data specifying information necessary to create listings requested by a provider 106, data specifying the quantity of a given item that a user of user device 102 is requesting to obtain. The front-end servers 112 can also receive, from the back-end servers 114, data for a particular user of a user device 102 or a provider device 106, and transmit the data to the appropriate user device 102 or provider device 106 over the network 104.

The back-end server 114 can include an item engine 116, a search engine 120, and a neural network 130. As used in this specification, the term engine refers to hardware, e.g., one or more data processing apparatuses, that execute software that performs a set of tasks. The operations of these engines as described in this specification may be performed, wholly or in part, by one or more other engines. In other words, some implementations may include more than the two engines depicted in FIG. 1 to perform the operations described in this specification. Alternatively, some implementations may include fewer engines to perform the operations described in this specification. Further still, even if an implementation includes the same two engines depicted in FIG. 1, the operations performed by one of these engines, as described in this specification, may be performed by one or more of the other engines.

The item engine 116 manages the creation and modification of listings of items, as requested by a provider via application 106-A on a provider device 106. The item engine 116 can receive from the front-end servers 112, data specifying a description of an item for a listing initiated by a provider. Based on this description, the item engine 116 can create the listing within the exchange platform 110. The description of the item can include, for example, a name for the item, a brief description of the item, a quantity of the item, an amount required to obtain the particular item, an amount required to deliver the item to a destination, a fulfillment time for the item to arrive at the destination, and one or more images of the item. The item engine 116 can use some or all of this information to create a listing for the item on the exchange platform 110. The item engine 116 can store the data for the listing, including the received information, in an item listings data storage 124. The item listings data storage 124 can include one or more databases (or other appropriate data storage structures) stored in one or more non-transitory data storage media (e.g., hard drive(s), flash memory, etc.).

The item engine 116 can also receive from the front-end servers 112, data specifying attributes of an item listing that a provider 106 may want to modify. For example, provider 106, through application 106-A, may seek to modify one or more attributes of the provider's item listed on the exchange platform 110. The modified attributes are communicated from the application 106-A to front-end server 112 over network 104. The item engine 116 in turn receives from the front-end servers 112, data specifying attributes of the item listing that the provider 106 wants to modify.

The search engine 120 can receive from the front-end servers 112 data specifying user's request to view one or more listings of items, search for items, and/or obtain an item. If a user searches for an item or a digital component, on the exchange platform, the user's query is received by the front-end servers 112, which in turn sends the query to the search engine 120. The search engine 120 uses the data specified in the query to identify appropriate listings stored in the item listing data storage 124. The search engine 120 can include a retrieval engine 132 and a ranking engine 134. The retrieval engine 132 can retrieve the listings from the item listing data storage 124 based on the user data specified in the query, while the ranking engine 134 can rank the listings based on ranking factors to generate a ranked set of listings. The search engine 120 can communicate the ranked set of listings to the front-end server 112, which in turn can provide the set of ranked listings to the application 102-A. The user may select a link for one listing from among the set of ranked listings. The application 102-A can send the selected link to the front-end server 112, which can interpret the user's selection as a request for data about the selected listing. The front-end servers 112 request the item engine 116 to provide data about the selected listings, which the item engine 116 obtains from the item listing data storage 124. The item engine 116 communicates the obtained data to the front-end servers 112, which in turn communicate the data to the application 102-A in the form of a page showing the data of the selected listing.

When a user views a listing for an item on the exchange platform displayed on the application 102-A, the user may decide to obtain the item. The user may select a button (or other appropriate user interface element) on the interface presented on application 102-A, which may result in the front-end servers 112 providing a different user interface to the user where the user can enter pertinent details (e.g., quantity of the item, the destination address, payment information) to begin the fulfillment process for purchasing the item. Upon submitting this information (e.g., by clicking a submit button on the user interface), the details entered by the user along with attributes of the item that the user wants are received by the front-end servers 112 and passed to the item engine 116. The item engine 116 evaluates whether the received data is valid (e.g., whether the quantity of the item requested by the user is the same or less than the available quantity of the item, whether the shipping address is correct, whether the payment information is correct).

If the data received from the user is invalid, the item engine 116 sends a message to the front-end servers indicating that the request is denied along with a reason explaining why the request was denied (e.g., credit card was not approved or invalid shipping address). The front-end servers 112 can provide a new user interface for presentation in application 102-A, in which the user is notified that the user's request was unsuccessful.

If, however, the data received from the user is valid, the item engine 116 processes the payment using the received payment information and sends a message, including the received user data, to the appropriate provider to begin the fulfillment process. The item engine 116 may store acquisition information about the item (e.g., identifier of the user acquiring the item, the quantity of the item acquired, the amount provided for the item, the date of acquisition) in a acquisition data storage device 128. The acquisition data storage device 128 can include one or more databases (or other appropriate data storage structures) stored in one or more non-transitory data storage media (e.g., hard drive(s), flash memory, etc.). Subsequently, the item engine 116 can send a message to the front-end servers 112, indicating that fulfillment processing has begun. Upon receiving this message from the item engine 116, the front-end servers 112 can provide a new user interface for presentation in application 102-A, in which the user is notified that the user's request was successful and that the order processing has begun.

The neural network 130 can communicate with the search engine 120, and in particular with the ranking engine 134, to carry out inference operations on the set of listings identified by the retrieval engine 132 and provide scores associated with each listings. The ranking engine 134 can rank the set of listings based in part on the scores provided by the neural network 130. The neural network 130 can include neural networks configured to process sequential data such as recurrent neural networks (RNNs), long short-term memory (LSTM), gated recurrent units (GRUs), etc. The neural network 130 can include more than one neural network. For example, the neural network 130 can include different neural networks trained for different inferences. As discussed further below, the neural network 130 can be trained on data stored in training data storage device 126. The training data can include labeled data including user, query, and listings interaction sequences from several categories (e.g., regions or countries).

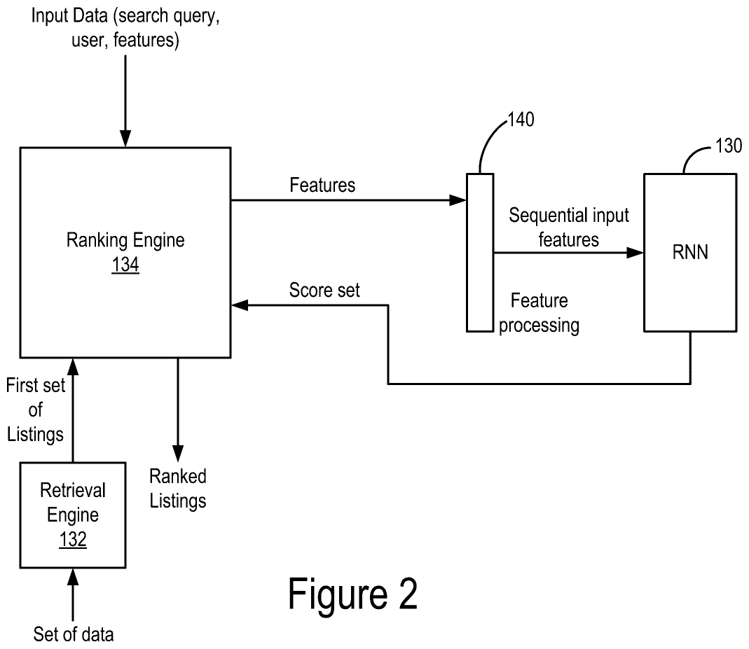

FIG. 2 shows a block diagram of a portion of the exchange platform 110 discussed in relation to FIG. 1. Specifically, the FIG. 2 shows the dataflow between retrieval engine 132, the ranking engine 134, and the neural network 130. The front-end server 112 can receive a set of data, which can include at least one of data related to a user-submitted query and interaction data, from the application 102-A and communicate the received set of data to the back-end servers 114. The user-submitted query can include data such as text, image, audio, or other media that the user provides for searching listings or data components on the exchange platform 110. The interaction data can include sequence of interactions by the user when sending the query. For example, the interaction data can include a sequence of links clicked by the user prior to sending the query. In some instances, the set of data can include user data, which can include information about the user such as name, contact information, location, username preferences, etc. In some examples, the user data can be previously stored at the exchange platform 110 associated with an identity of the user (e.g., username) and the front-end servers 112 or the back-end servers 114 can retrieve the user data based on the identity of the user and provide the user data to the retrieval engine 132.

The retrieval engine 132 can retrieve listings from the item listing data storage 124 based on the set of data received from the user device 102. For example, the retrieval engine 132 can use the user-submitted query to search for listings relevant to the query in the item listing data storage 124. The retrieval engine 132 can identify a first set of listings that are relevant to the query. Each listing in the first set of listings can correspond to a listing of digital component provided on the exchange platform. The retrieval engine 132 can provide the first set of listings to the ranking engine 134 for generating a ranked list. The ranking engine can rank the first set of listings based in part on a set of sequential output scores for each listing provided by the neural network 130. The set of sequential output scores (also referred to as a “set of scores”) can include scores associated with each task of a sequence of tasks. For example, if the tasks include “click” and “acquire,” the set of scores can include a score for the “click” task and a score for the “acquire” task. The scores can indicate the probability that a particular listing will result in the user executing the respective tasks. The ranking engine 134 can generate a rank for each listing based on set of scores for the listing. Based on the generated rank, the ranking engine 134 can rank the first set of listings to generated a ranked set of listings that are ordered based on the generated ranks.

The neural network 130 also can receive additional information such as raw set of input features, category information (e.g., region), category or region-variant features, category or region variant features, etc. to generate the set of scores. As discussed herein, the neural network can utilize this additional information to provide a more accurate score to rank the listings. The raw set of input features can include features such as listing views per query count, user gift acquisition count, etc. In some examples, the raw set of input features can also include user related features such as number of purchases, total order value, and number of clicks in the last x days, where the clicks refer to clicks by the user on the application 102-A that presents information received from the exchange platform 110. In some examples, the raw set of input features can also include query-based features such as query text, query popularity bin (where queries are distributed in various popularity bins), a number of historical clicks, and a number of purchases associated with the query. In some examples, the raw set of input features can also include listing-based features such as listing titles, listing tags, a number of purchases associated with the listing. The ranking engine 134 can identify from the raw set of input features, a set of region specific (or generally category specific) features and a set of region-invariant (or generally category invariant) features. The ranking engine 134 can identify the two types of features based on the distribution of the features (discussed below). The region-invariant features and the region variant features can be provided to a features processing block 140, which generates sequential input features. The features processing block 140 can transform the non-sequential features into sequential features, which can be provided to the neural network 130. The features processing block 140 can process region-invariant features using a set of initial layers of the neural network 130 to generate a transformed set of region-invariant features. The features processing block 140 can process the region variant features based on region specific mask weights to generate a combined set of region variant features. The combined set of region variant features and the transformed set of region-invariant features can be combined to generate a set of sequential features, which are provided to the remainder of the neural network 130.

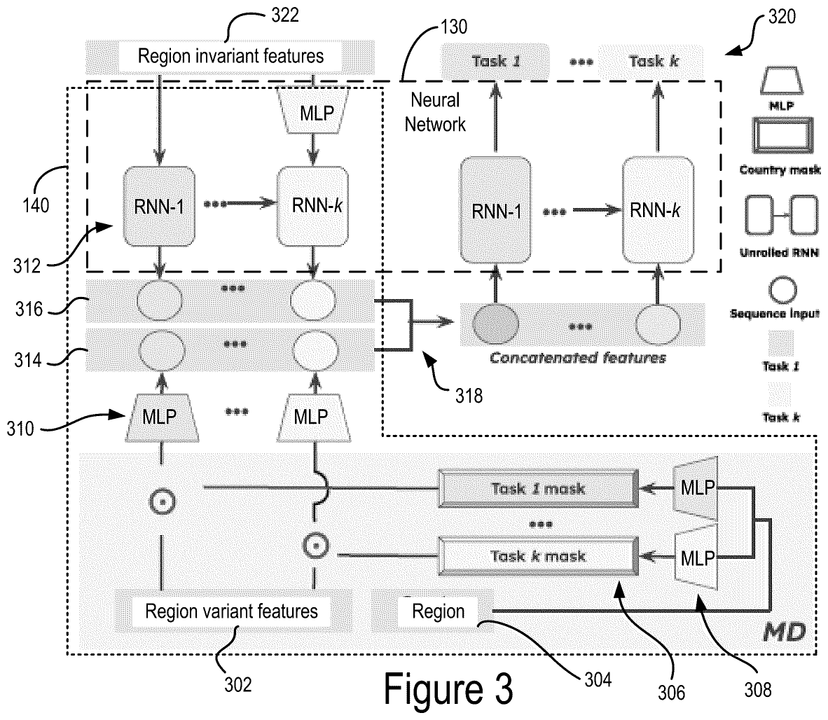

FIG. 3 shows a block diagram with additional details of the ranking engine 134 and the neural network 130 discussed herein in relation to FIGS. 1 and 2. The region variant features 302 are multiplied with region variant mask weights generated by mask generation modules 306. The number of masks is equal to the number of region variant features 302 such that each region variant feature is multiplied by the respective mask weight from the mask weights generated by the mask generation modules 306. In some examples, the region variant features 302 can include k region variant features and the number of mask weights can be equal to k. The product of the multiplication of the region variant features 302 with the region variant mask weights are processed through multi-layer perceptron (MLPs) 310 to generate a combined set of region variant features 314.

The region-invariant features 322 are provided to an initial set of layers 312 of the neural network 130. The initial set of layers 312 of the neural network 130 transform the region-invariant features 322 into a transformed set of region-invariant features 316. The transformed set of region-invariant features 316 can be combined with the combined set of region variant features 314 to obtain the set of sequential input features 318. In some examples, the transformed set of region-invariant features 316 can be concatenated with the combined set of region variant features 314. The set of sequential input features 318 are provided to the remainder of the neural network 130, which generates a set of sequential output scores 320 for each task k. In some examples, the ranking engine 134 can the ranking engine 134 can determine a dot product of the transformed set of regional-invariant features 316 and the combined set of region variant features 314. The result of the dot product can represent a degree of similarity between the features. The result of the dot product can be used as a weight vector to multiply with the transformed set of regional-invariant features 316 to obtain the set of sequential input features 318, which can be provided to the neural network 130. That is, instead of providing the neural network 130 with a concatenation of the transformed set of region-invariant features 136 and the transformed set of regional-invariant features 316, the weighted transformed set of regional-invariant features are provided to the neural network 130. In another approach, the set of sequential input features 318 can be generated based on max-pooling or averaging the transformed set of regional-invariant features 316 and the combined set of region variant features 314. In yet another approach, instead of directly concatenating the transformed set of region-invariant features 136 and the combined set of region variant features 314, the transformed set of region-invariant features 316 can be passed through a shallow neural network, and the output of the shallow neural network can be concatenated with the combined set of region variant features 314 to generate the set of sequential input features 318.

The neural network 130 is responsible of multi-sequential-task learning. In particular, the multi-task learning architecture of the neural network 130 can make predictions for the k tasks simultaneously given a single input X, whereas the portion of the architecture that generates the combined set of region variant features is a multi-distribution learning model and is designed for unified learning across the entire input set {(Xᵢ)}ᵢ₌₁ⁿ, where the distribution of X for certain regions shows significant differences compared to other regions.

Referring again to the multi-sequential neural network 130, some tasks naturally form a sequence, e.g., click, add to cart, acquire, where each action occurs in a sequential order, conditional on the previous ones. However, most multi-task learning architectures do not account for the sequential nature of the problem, making the output tasks order-agnostic and interchangeable. Introducing order into multi-task learning offers several benefits. First, sequential ordering allows the model to prioritize more complex tasks later in the sequence. In e-commerce, those later tasks (e.g. acquire) are often more critical than earlier (e.g. click) task because of their higher monetization values. At the same time, the data sparsity of the acquisition task makes it more difficult to optimize. By establishing a sequence, knowledge from earlier (and typically easier) tasks can be used to address later (and often harder) tasks. Second, sequential ordering facilitates the transfer or addition of new tasks. Since the model learns tasks in a “continuous” manner, adding new tasks in the sequence requires minimal training cost. To facilitate the sequential nature of learning, the neural network 130 includes connected RNNs such that the prediction of later user actions are conditioned on previous actions. Each layer of the RNN shares the same set of weights, with the only difference being the input token and the hidden input from previous tokens.

$$[ {X}_{i}^{0} , … , {X}_{i}^{k - 1} ] = [ {X}_{i} , … , {MLP}^{k - 1} ( {X}_{i} ) ] \qquad Eq . 1$$

Equation 1 represents the approach taken in the architecture discussed herein, where a single feature is processed through an MLP for each token, transforming the input feature specifically for each task. The hidden input can be seen as the knowledge passed down from previous actions.

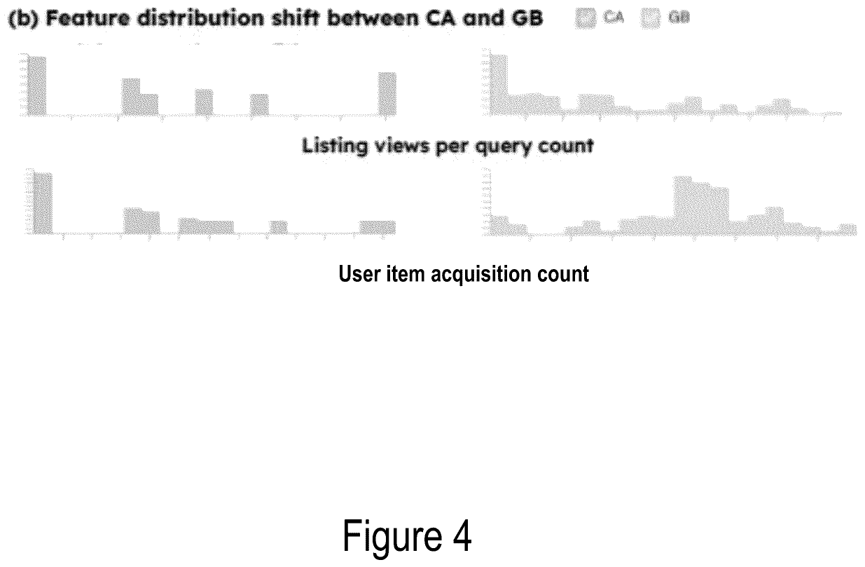

Referring to FIG. 3, the region variant features 302 can be identified from raw inputs based on comparison of the region based distributions of the features. Examples of features with varying region based distributions are presented in FIG. 4.

FIG. 4 shows example region based distributions of features. In particular, FIG. 4 shows distributions of two features: “Listing views per query count” and “User gift acquisition count” for two regions: Canada and Great Britain. For the two distributions of the Listing views per query count, significant differences can be seen between the distribution for Canada verses the distribution for Great Britain. Similarly, the distribution for User gift acquisition count in Canada differs significantly from the distribution in Great Britain. In some instances, the ranking engine 134 can be responsible for identifying region variant features from region-invariant features given a set of raw features. In one example, the ranking engine 134 can compare the distributions of a feature across various regions and if the distributions differ over a threshold value, the ranking engine 134 can indicate that the feature is region variant. If the distributions do not differ over a threshold value, the ranking engine 134 can indicate the features as being region invariant. In some examples, statistical techniques such as Kullback-Leibler divergence, f-divergence, Kolmogorov-Smirnov test (for continuous distribution), or Chi-squared test (for discrete distributions) may also be used by the ranking engine 134 to determine whether the features are region invariant.

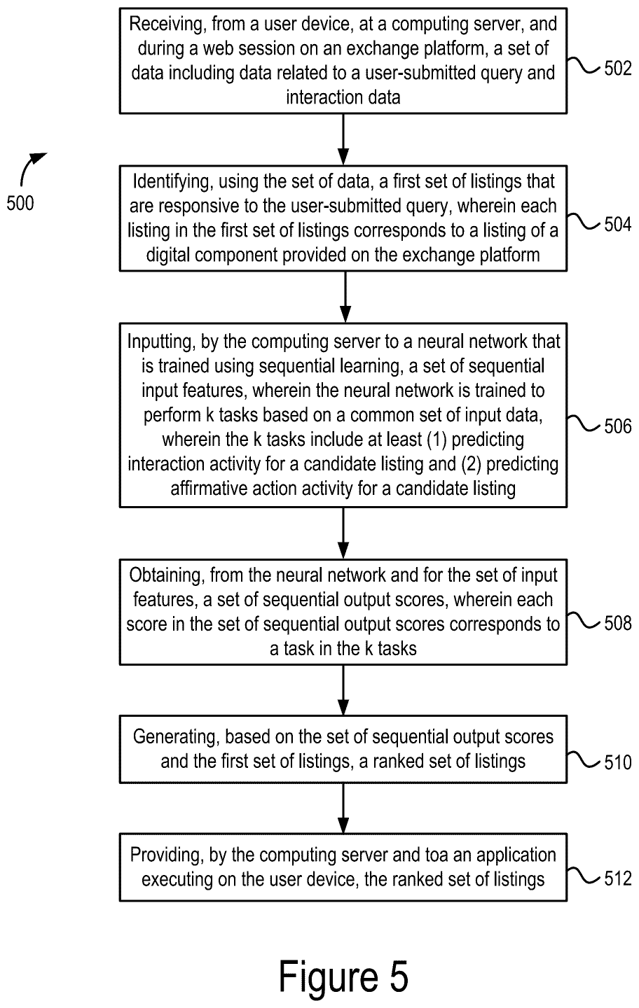

FIG. 5 shows a flow diagram of an example process 500 for ranking listings. the process 500 can be executed by the search engine 120 and the neural network 130. The process 500 includes receiving, from a user device, at a computing server, and during a web session on an exchange platform, a set of data including data related to a user-submitted query and interaction data (502). Referring to FIG. 1, user devices 102 can include applications 102-A that can allow a user to initiate a web session with the front-end servers 112 of the exchange platform 110. The web session can include the user browsing a merchant website provided by the exchange platform 110. A web page presented to the user by the application 102-A can include fields where the user can make selections or search for items. Once the user enters a user-submitted query, the application 102-A can send data related to the user-selected query to the front-end servers 112. The set of data can include the query submitted by the user. The query can be in the form of text, photo, audio, audio visual, or other formats. The set of data can also include information about the location of the user. The location can be a country, state, city, neighborhood, etc.

The process 500 further includes identifying, using the set of data, a first set of listings that are responsive to the user-submitted query, where each listing in the first set of listings corresponds to a listing of a digital component provided on the exchange platform (504). The front-end server 112 can provide the set of data related to the user-submitted query to the back-end servers 114, and in particular to the search engine 120. The retrieval engine 132 can use the set of data, such as the search query, and search the item listing data storage 124 to identify a first set of listings of digital components. The search engine 132 can use keyword search, for example when the user submitted query is text, to identify relevant listings.

The process 500 also includes inputting, by the computing server to the neural network that is trained using sequential learning, a set of sequential input features, wherein the neural network is trained to perform k tasks based on a common set of input data, wherein the k tasks include at least (1) predicting interaction activity for a candidate listing and (2) predicting affirmative action activity for the candidate listing (506). The search engine 120 can provide each listing in the first set of listings to the neural network to determine a set of sequential output scores for the listing. The neural network can include the neural network 130 discussed herein in relation to FIGS. 2 and 3. The neural network 130 is trained for example, on a data set that includes <user, query, listing> interaction sequences from several regions. The k tasks can include actions such as “click,” “put in cart,” “acquire,” etc. The “click” action can be considered as an interaction activity, while the action “acquire” can be considered as affirmative action activity.

The process 500 also includes obtaining, from the neural network and for the set of input features, a set of sequential output scores, wherein each score in the set of sequential output scores corresponds to a task in the k tasks (508). The neural network 130 can generate a set of scores, where the scores can indicate a probability of the user taking the action given the listing. For example, the neural network 130 can provide a probability that the user will “click” on the listing or a probability that the user will “acquire” the item on the listing.

The process 500 further includes generating, based on the set of sequential output scores and the first set of listings, a ranked set of listings (510). The ranking engine 134 can obtain the set of sequential output scores for each listing. In some instances, the ranking engine 134 can sum the scores for all tasks to arrive at a ranking score for the listing. In some other instances, the ranking engine 134 may utilize a different formula, such as a weighted sum, to arrive at the ranking score from the set of sequential output scores. The ranking engine 134 can determine the ranking score for each listing, and order the listings in the first set of listings based on their ranking scores and generate a ranked set of listings.

The process 500 also includes providing, by the computing server and to an application on the user device, the ranked set of listings (512). The ranking engine 134 can provide the ranked set of listings to the front-end server 112, which, in turn, can provide the ranked set of listings to the application 102-A running on the user device 102. The application 102-A can, for example, display the ranked set of listings to the user for further consideration by the user. Displaying the ranked set of listings to the user ensures that listings that have historically resulted in greater user interaction are displayed first.

In some examples, the process can include generating the set of sequential input features. For example, the feature processing block 140 can be employed to generate the set of sequential input features from a raw set of features. The raw set of features can include features such as listings view per query count, user gift acquisition count, etc. The feature processing block 140 can then identify, from among the raw set of input features, a set of region-variant features and a set of region-invariant features. As discussed above in relation to FIG. 4, the distributions of the features across regions can be compared to determine whether the distributions differ over a threshold value. If the distributions differ over the threshold value, the feature processing block 140 can identify the feature as a region-variant features. If, on the other hand, the distributions across the regions do not differ over a threshold value, the feature processing block 140 can identify that feature as a region-invariant feature. The feature processing block 140 can generate, for a particular region, a set of region-variant mask weights. The number of mask weights generated can be equal to the number of region-variant features. In some instances, the number of region-variant features k can be equal to the number of tasks k. One approach to generating the set of region-variant mask weights is to generate an embedding layer based on the name of the regions and use a multi-layer perceptron to convert the embeddings in the embeddings layer into the set of region-variant mask weights. The embedding layer can be trained as part of the training of the neural network 130.

The feature processing block 140 can combine the region-variant mask weights with the set of region-variant features to obtain a combined set of region-variant features. For example, the feature processing block 140 can multiply each region-variant feature with the corresponding mask weight to generate the combined set of region-variant features. The feature processing block 140 can also process, using an initial set of layers of the neural network, the set of region-invariant features to obtain a transformed set of region-invariant features. For example, referring to FIG. 3, the initial set of layers 312 of the neural network 130 can be used to process the region-invariant features 322 to generate the transformed set of region-invariant features 316. The feature processing block 140 also can combine the transformed set of region-invariant features with the combined set of region-variant features to obtain the set of sequential input features. For example, referring to FIG. 3, the feature processing block 140 can concatenate the transformed set of region-invariant features 316 with the combined set of region-variant features 314 to generate the set of sequential input features 318.

The components and processes discussed herein can be implemented on a computing system. In particular, a computing system including a computing device and/or a mobile computing device can be used to implement the techniques described herein. For example, one or more processes, electronic design tools, and data can be implemented on or stored in the computing device or the mobile computing device.

The computing device is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only, and are not meant to be limiting.

The computing device includes a processor, a memory, a storage device, a high-speed interface connecting to the memory and multiple high-speed expansion ports, and a low-speed interface connecting to a low-speed expansion port and the storage device. Each of the processor, the memory, the storage device, the high-speed interface, the high-speed expansion ports, and the low-speed interface, are interconnected using various busses, and may be mounted on a common motherboard or in other manners as appropriate. The processor can process instructions for execution within the computing device, including instructions stored in the memory or on the storage device to display graphical information for a GUI on an external input/output device, such as a display coupled to the high-speed interface. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor is a single threaded processor. In some implementations, the processor is a multi-threaded processor. In some implementations, the processor is a quantum computer.

The memory stores information within the computing device. In some implementations, the memory is a volatile memory unit or units. In some implementations, the memory is a non-volatile memory unit or units. The memory may also be another form of computer-readable medium, such as a magnetic or optical disk.

The storage device is capable of providing mass storage for the computing device. In some implementations, the storage device may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor), perform one or more methods, such as those described above. The instructions can also be stored by one or more storage devices such as computer-or machine-readable mediums (for example, the memory, the storage device, or memory on the processor). The high-speed interface manages bandwidth-intensive operations for the computing device, while the low-speed interface manages lower bandwidth-intensive operations. Such allocation of functions is an example only. In some implementations, the high-speed interface is coupled to the memory, the display (e.g., through a graphics processor or accelerator), and to the high-speed expansion ports, which may accept various expansion cards (not shown). In the implementation, the low-speed interface is coupled to the storage device and the low-speed expansion port. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device may be implemented in a number of different forms, as shown in the figure. For example, it may be implemented as a standard server, or multiple times in a group of such servers. In addition, it may be implemented in a personal computer such as a laptop computer. It may also be implemented as part of a rack server system. Alternatively, components from the computing device may be combined with other components in a mobile device, such as a mobile computing device. Each of such devices may include one or more of the computing device and the mobile computing device, and an entire system may be made up of multiple computing devices communicating with each other.

The mobile computing device includes a processor, a memory, an input/output device such as a display, a communication interface, and a transceiver, among other components. The mobile computing device may also be provided with a storage device, such as a micro-drive or other device, to provide additional storage. Each of the processor, the memory, the display, the communication interface, and the transceiver, are interconnected using various buses, and several of the components may be mounted on a common motherboard or in other manners as appropriate.

The processor can execute instructions within the mobile computing device, including instructions stored in the memory. The processor may be implemented as a chipset of chips that include separate and multiple analog and digital processors. The processor may provide, for example, for coordination of the other components of the mobile computing device, such as control of user interfaces, applications run by the mobile computing device, and wireless communication by the mobile computing device.

The processor may communicate with a user through a control interface and a display interface coupled to the display. The display may be, for example, a TFT (Thin-Film-Transistor Liquid Crystal Display) display or an OLED (Organic Light Emitting Diode) display, or other appropriate display technology. The display interface may include appropriate circuitry for driving the display to present graphical and other information to a user. The control interface may receive commands from a user and convert them for submission to the processor. In addition, an external interface may provide communication with the processor, so as to enable near area communication of the mobile computing device with other devices. The external interface may provide, for example, for wired communication in some implementations, or for wireless communication in other implementations, and multiple interfaces may also be used.

The memory stores information within the mobile computing device. The memory can be implemented as one or more of a computer-readable medium or media, a volatile memory unit or units, or a non-volatile memory unit or units. An expansion memory may also be provided and connected to the mobile computing device through an expansion interface, which may include, for example, a SIMM (Single In Line Memory Module) card interface. The expansion memory may provide extra storage space for the mobile computing device, or may also store applications or other information for the mobile computing device. Specifically, the expansion memory may include instructions to carry out or supplement the processes described herein and may include secure information also. Thus, for example, the expansion memory may be provided as a security module for the mobile computing device, and may be programmed with instructions that permit secure use of the mobile computing device. In addition, secure applications may be provided via the SIMM cards, along with additional information, such as placing identifying information on the SIMM card in a non-hackable manner.

The memory may include, for example, flash memory and/or NVRAM memory (nonvolatile random access memory), as discussed below. In some implementations, instructions are stored in an information carrier such that the instructions, when executed by one or more processing devices (for example, processor), perform one or more methods, such as those described above. The instructions can also be stored by one or more storage devices, such as one or more computer-or machine-readable mediums (for example, the memory, the expansion memory, or memory on the processor). In some implementations, the instructions can be received in a propagated signal, for example, over the transceiver or the external interface.

The mobile computing device may communicate wirelessly through the communication interface, which may include digital signal processing circuitry in some cases. The communication interface may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 4G/5G/6G cellular, among others. Such communication may occur, for example, through the transceiver using a radio frequency. In addition, short-range communication may occur, such as using a Bluetooth, Wi-Fi, or other such transceiver (not shown). In addition, a GPS (Global Positioning System) receiver module may provide additional navigation-and location-related wireless data to the mobile computing device, which may be used as appropriate by applications running on the mobile computing device.

The mobile computing device may also communicate audibly using an audio codec, which may receive spoken information from a user and convert it to usable digital information. The audio codec may likewise generate audible sound for a user, such as through a speaker, e.g., in a handset of the mobile computing device. Such sound may include sound from voice telephone calls, may include recorded sound (e.g., voice messages, music files, among others) and may also include sound generated by applications operating on the mobile computing device.

The mobile computing device may be implemented in a number of different forms, as shown in the figure. For example, it may be implemented as a cellular telephone. It may also be implemented as part of a smart-phone, personal digital assistant, or other similar mobile device.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

The processes and logic flows can also be performed by special purpose logic circuitry, e.g., an FPGA or an ASIC, or by a combination of special purpose logic circuitry and one or more programmed computers. Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method, comprising:
receiving, from a user device, at a computing server, and during a web session on an exchange platform, a set of data including data related to a user-submitted query and interaction data;
identifying, using the set of data, a first set of listings that are responsive to the user-submitted query, wherein each listing in the first set of listings corresponds to a listing of a digital component provided on the exchange platform;
inputting, by the computing server to a neural network that is trained using sequential learning, a set of sequential input features, wherein the neural network is trained to perform k tasks based on a common set of input data, wherein the k tasks include at least (1) predicting interaction activity for a candidate listing and (2) predicting affirmative action activity for the candidate listing;
obtaining, from the neural network and for the set of input features, a set of sequential output scores, wherein each score in the set of sequential output scores corresponds to a task in the k tasks;
generating, based on the set of sequential output scores and the first set of listings, a ranked set of listings; and
providing, by the computing server and to an application executing on the user device, the ranked set of listings.

2. The computer-implemented method of claim 1, further comprising:
generating a raw set of input features using the received set of data;
identifying, from among the raw set of input features, a set of region-variant features and a set of region-invariant features;
generating, for a particular region, a set of region-variant mask weights;
combining the set of region-variant mask weights with the set of region-variant features to obtain a combined set of region-variant features;
processing, using an initial layer of the neural network, the set of region-invariant features to obtain a transformed set of region-invariant features; and
combining the transformed set of region-invariant features with the combined set of region-variant features to obtain the set of sequential input features.

3. The computer-implemented method of claim 2, further comprising:
comparing region-based distributions of the raw set of input features;
identifying those raw set of features that have region-based distributions that different over a threshold value as the region-variant features and the remainder of the raw set of features as region-invariant features.

4. The computer-implemented method of claim 2, wherein combining the set of region-variant mask weights with the set of region-variant features to obtain the combined set of region-variant features includes multiplying the set of region-variant mask weights with the set of region-variant features to obtain the combined set of region-variant features.

5. The computer-implemented method of claim 2, wherein a number of region-variant mask weights in the set of region-variant mask weights is equal to a number k of tasks.

6. The computer-implemented method of claim 2, wherein the region-invariant features are transformed into a sequence in the transformed set of region-invariant features and the set of region-variant features are transformed into a sequence in the combined set of region-variant features.

7. The computer-implemented method of claim 1, wherein the neural network is trained on sequential data capturing a user interaction with a listing, the user interaction including at least one of a click task, an add to cart task, and an acquisition task.

8. The computer-implemented method of claim 1, further comprising:
generating the ranked set of listings from the first set of listings based on a single score resulting from a weighted sum of the set of sequential output scores.

9. One or more non-transitory computer-readable storage media storing instructions that when executed by one or more processors cause the one or more processors to perform operations for providing a ranked set of listings, the operations comprising:
receiving, from a user device, at a computing server, and during a web session on an exchange platform, a set of data including data related to a user-submitted query and interaction data;
identifying, using the set of data, a first set of listings that are responsive to the user-submitted query, wherein each listing in the first set of listings corresponds to a listing of a digital component provided on the exchange platform;
inputting, by the computing server to a neural network that is trained using sequential learning, a set of sequential input features, wherein the neural network is trained to perform k tasks based on a common set of input data, wherein the k tasks include at least (1) predicting interaction activity for a candidate listing and (2) predicting affirmative action activity for the candidate listing;
obtaining, from the neural network and for the set of input features, a set of sequential output scores, wherein each score in the set of sequential output scores corresponds to a task in the k tasks;
generating, based on the set of sequential output scores and the first set of listings, a ranked set of listings; and
providing, by the computing server and to an application executing on the user device, the ranked set of listings.

10. The computer-readable storage media of claim 9, the operations further comprising:
generating a raw set of input features using the received set of data;
identifying, from among the raw set of input features, a set of region-variant features and a set of region-invariant features;
generating, for a particular region, a set of region-variant mask weights;
combining the set of region-variant mask weights with the set of region-variant features to obtain a combined set of region-variant features;
processing, using an initial layer of the neural network, the set of region-invariant features to obtain a transformed set of region-invariant features; and
combining the transformed set of region-invariant features with the combined set of region-variant features to obtain the set of sequential input features.

11. The computer-readable storage media of claim 10, the operations further comprising:
comparing region-based distributions of the raw set of input features;
identifying those raw set of features that have region-based distributions that different over a threshold value as the region-variant features and the remainder of the raw set of features as region-invariant features.

12. The computer-readable storage media of claim 10, wherein combining the set of region-variant mask weights with the set of region-variant features to obtain the combined set of region-variant features includes multiplying the set of region-variant mask weights with the set of region-variant features to obtain the combined set of region-variant features.

13. The computer-readable storage media of claim 10, wherein a number of region-variant mask weights in the set of region-variant mask weights is equal to a number k of tasks.

14. The computer-readable storage media of claim 10, wherein the region-invariant features are transformed into a sequence in the transformed set of region-invariant features and the set of region-variant features are transformed into a sequence in the combined set of region-variant features.

15. The computer-readable storage media of claim 9, wherein the neural network is trained on sequential data capturing a user interaction with a listing, the user interaction including at least one of a click task, an add to cart task, and an acquisition task.

16. The computer-readable storage media of claim 9, the operations further comprising:
generating the ranked set of listings from the first set of listings based on a single score resulting from a weighted sum of the set of sequential output scores.

17. A system, comprising:
one or more processors; and
one or more storage devices storing instructions that when executed by the one or more processors to perform operations for providing a ranked set of listings, the operations comprising:
receiving, from a user device, at a computing server, and during a web session on an exchange platform, a set of data including data related to a user-submitted query and interaction data;
identifying, using the set of data, a first set of listings that are responsive to the user-submitted query, wherein each listing in the first set of listings corresponds to a listing of a digital component provided on the exchange platform;
inputting, by the computing server to a neural network that is trained using sequential learning, a set of sequential input features, wherein the neural network is trained to perform k tasks based on a common set of input data, wherein the k tasks include at least (1) predicting interaction activity for a candidate listing and (2) predicting affirmative action activity for the candidate listing;
obtaining, from the neural network and for the set of input features, a set of sequential output scores, wherein each score in the set of sequential output scores corresponds to a task in the k tasks;
generating, based on the set of sequential output scores and the first set of listings, a ranked set of listings; and
providing, by the computing server and to an application executing on the user device, the ranked set of listings.

18. The system of claim 17, the operations further comprising:
generating a raw set of input features using the received set of data;
identifying, from among the raw set of input features, a set of region-variant features and a set of region-invariant features;
generating, for a particular region, a set of region-variant mask weights;
combining the set of region-variant mask weights with the set of region-variant features to obtain a combined set of region-variant features;
processing, using an initial layer of the neural network, the set of region-invariant features to obtain a transformed set of region-invariant features; and
combining the transformed set of region-invariant features with the combined set of region-variant features to obtain the set of sequential input features.

19. The system of claim 18, the operations further comprising:
comparing region-based distributions of the raw set of input features;
identifying those raw set of features that have region-based distributions that different over a threshold value as the region-variant features and the remainder of the raw set of features as region-invariant features.

20. The system of claim 18, wherein combining the set of region-variant mask weights with the set of region-variant features to obtain the combined set of region-variant features includes multiplying the set of region-variant mask weights with the set of region-variant features to obtain the combined set of region-variant features.

21. The system of claim 18, wherein a number of region-variant mask weights in the set of region-variant mask weights is equal to a number k of tasks.

22. The system of claim 18, wherein the region-invariant features are transformed into a sequence in the transformed set of region-invariant features and the set of region-variant features are transformed into a sequence in the combined set of region-variant features.

23. The system of claim 17, wherein the neural network is trained on sequential data capturing a user interaction with a listing, the user interaction including at least one of a click task, an add to cart task, and an acquisition task.

24. The system of claim 17, the operations further comprising:
generating the ranked set of listings from the first set of listings based on a single score resulting from a weighted sum of the set of sequential output scores.
